(19) United States
(12) Patent Application Publication
(10) Pub. No.: US 2013/0285496 A1
(43) Pub. Date: Oct. 31, 2013

(54) Miniature Motor and Bearing Arrangement

(71) Applicant: MultiElectric GmbH & Co. KG, Stuttgart (DE)

(72) Inventors: Dario BOCCADAMO, Stuttgart (DE); Joachim Friebe, Weinstadt (DE)

(21) Appl. No.: 13/775,743

(22) Filed: Feb. 25, 2013

(30) Foreign Application Priority Data
Mar. 5, 2012 (DE) 10 2012 101 824.3

(51) Int. Cl. H02K 5/167

(52) U.S. Cl. CPC H02K 5/1672
USPC 310/90

(57) ABSTRACT

Electric miniature motor comprises bearings; stationary assemblies having end faces; and metallic configurations disposed at the end faces for seating the bearings. At least one of the bearings is a sleeve bearing of sintered material inserted into a massive ring of weldable material, the outer diameter of which is smaller than the inner diameter of the corresponding configuration for seating; and the ring is connected by at least one welded joint to the configuration for seating.

### FIELD OF THE INVENTION

The present invention relates to electric miniature motors and a bearing arrangement for those.

### STATE OF THE ART

Nowadays, miniature motors are used in various applications. Those include drives in home appliances, hand tools, actuators in motor vehicles and the like. The demands upon the motors are steadily increasing, including a lower noise generation besides a higher performance.

A major noise source can be the mounting of the rotor of the motor if axial and/or radial relative movements of the motor shaft can occur in the mounting positions for mounting the same. These movements are enabled by the tolerances required for fabricating the components of the motor, the reduction of which can only be obtained with a considerable cost effort.

Therefore, efforts have been made to minimize the mentioned relative movements without reducing the free movability of the shaft. Measures for achieving this object are described in EP 1 041 303 A1, DE 195 37 503 A1, DE 40 10 564 A1 and DE 10 2008 027 841 A1, for example. The solutions shown in these documents are still accompanied by a considerable effort regarding the components or the process.

The object of the present invention is thus to provide an electric miniature motor with a bearing system in which the bearing clearance of the shaft can be adjusted in narrow limits without the requirement that the individual components have to have narrow axial and radial tolerances.

It has now been found that this object can be achieved by fixing the bearing by welding, e.g. laser welding, in the bearing seat.

### SHORT DESCRIPTION OF THE INVENTION

The object of the present invention is an electric miniature motor, wherein metallic configurations for seating the bearings are formed at the end faces of the stationary assemblies and wherein at least one of the bearings is a sleeve bearing of a sintered material inserted into a massive ring of a weldable material which is connected by welding, e.g. laser welding, to the configuration.

### SHORT DESCRIPTION OF THE FIGURES

FIG. 1 illustrates a longitudinal section of a miniature motor including the common assemblies according to an embodiment of the present invention;

FIG. 2 is a detailed view of the mounting according to FIG. 1 with the welded joint 2.4;

FIG. 3 illustrates a top view of the configuration 2.1 for receiving the sleeve bearing having a ring 2.3 and a point-like welded joint 2.4;

FIG. 4 is a view similar to FIG. 3 with an axially positioned corrugated welded joint 2.4;

FIG. 5 is a view similar to FIG. 3 with a corrugated welded joint 2.4 positioned at the circumference of the configuration 2.1;

FIG. 6 illustrates in a longitudinal section similar to FIG. 2 another embodiment of the invention with a front-sided welding between the ring 2.3 and the configuration 2.1;

FIG. 7 illustrates in a longitudinal section similar to FIG. 2 another embodiment of the invention with a welding between the ring 2.3 and the configuration 2.1 if the ring 2.3 axially protrudes over the configuration 2.1;

FIG. 8 illustrates in a longitudinal section similar to FIG. 2 another embodiment of the invention with a welding between the ring 2.3 and the configuration 2.1 if the ring 2.3 is axially recessed behind the configuration 2.1;

FIG. 9 illustrates a top view according to FIGS. 6 to 8 with three welded joints 2.4.

### DETAILED DESCRIPTION OF THE INVENTION

A miniature motor according to the present invention substantially comprises a rotor assembly 1, a housing assembly 2 and a power transmission assembly 3. The components of these assemblies are sufficiently known from conventional motors and are thus only described here insofar as required for understanding the invention.

The housing assembly 2 and the power transmission assembly 3 have cylindrical configurations 2.1 and 3.1, respectively, receiving the bearings 2.2 and 3.2, respectively, in which in turn the shaft 1.1 of the rotor assembly 1 is mounted.

In the case of miniature motors, the bearings 2.2 and 3.2, respectively, are frequently configured as sleeve bearings made of a sintered material into the pores of which the oil for lubricating the shaft in the operation of the motor is introduced.

The axial clearance A of the shaft 1.1 is determined by the position of the bearings 2.2 and 3.2 in their respective seats 2.1 and 3.1, respectively, and the position of the components commutator 1.5, distance sleeve 1.4 and thrust washers 1.2 and 1.3. In order to be able to adjust the axial clearance A to a desired amount, at least one of the bearings 2.2 and 3.2 has to be axially displaceable and fixed after achieving the desired clearance A.

In the further description, it is exemplarily assumed that the bearing 3.2 is fixed in the cylindrical seat 3.1 and that the shaft 1.1 is axially displaceable in this bearing. Further, it is assumed that the bearing 2.2 is a sleeve bearing, and that it is to be positioned so that the axial movement of the rotor assembly 1 can be adjusted to a desired amount. This is achieved by mounting the rotor assembly 1 and axially displacing the bearing 2.2 in its seat 2.1 using suitable means or devices.

After adjusting the desired axial clearance A, the bearing 2.2 could be welded with its seat 2.1, e.g. by a laser. However, this process is complicated by the fact that the bearing 2.2 contains oil. In order to avoid this shortcoming, the bearing 2.2 is not introduced directly into the configuration 2.1, but it is surrounded before by a massive oil retaining ring 2.3 of weldable material. The bearing 2.2 is fixedly connected to this ring 2.3 which can be achieved by a press fit, for example.

The inner diameter of the configuration 2.1 is larger than the outer diameter of the ring 2.3, whereby it is possible that in a mounted motor in which the housing assembly 2 is already fixedly connected to the power transmission assembly 3 the bearing 2.2 is still movable axially and, in the limits of the diameter difference of the configuration 2.1 and the ring 2.3, also radially.

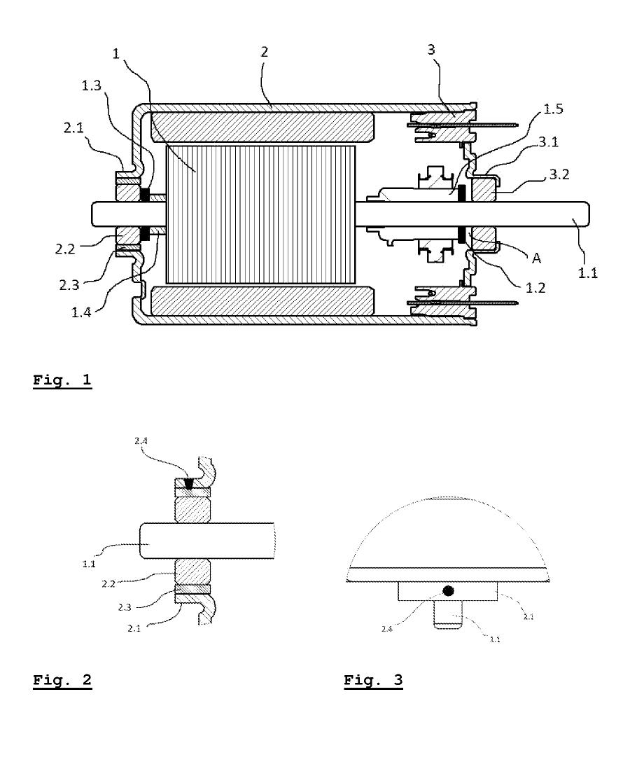

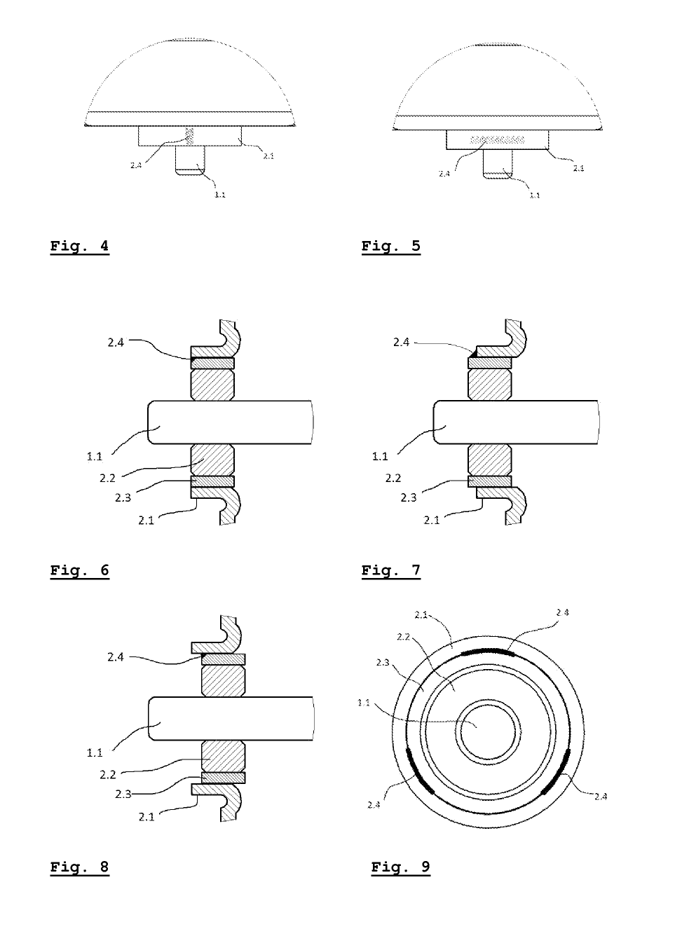

Using suitable means and devices, respectively, the rotor assembly 1 is brought into the desired position with respect to the housing assembly 2, and the ring 2.3 is then welded to the configuration 2.1, e.g. by a laser beam. The welding 2.4 can occur both at the ring 2.3 through the configuration 2.1, i.e. in radial direction (FIGS. 2 to 5), and in axial direction at the contact edge between the ring 2.3 and the configuration 2.1 (FIGS. 6 to 9). A combination of both welding directions is also possible. Each welded joint 2.4 can be point-like or corrugated, and it can be made at one or several positions or through a closed path.

Each individual welded joint 2.4 reaches a specific resistance against axial and radial forces acting upon the bearing 2.2. It is thus also possible to satisfy different requirements regarding these forces depending upon the use conditions of the motor by the number of welded joints 2.4 and their configuration or combination.

1. Electric miniature motor, comprising:
a) bearings;
b) stationary assemblies having end faces;
c) metallic configurations disposed at the end faces for seating the bearings;
d) at least one of the bearings is a sleeve bearing of sintered material inserted into a massive ring of weldable material, the outer diameter of which is smaller than the inner diameter of the corresponding configuration for seating; and
d) the ring is connected by at least one welded joint to the configuration for seating.

2. Electric miniature motor according to claim 1, wherein the welding occurs radially through the configuration with the ring.

3. Electric miniature motor according to claim 2, wherein the welded joint is formed point-like, as an axial corrugation or as a corrugation at the circumference of the configuration.

4. Electric miniature motor according to claim 1, wherein the welding between the ring and the configuration occurs at the contact edge between both components.

5. Electric miniature motor according to claim 4, wherein the welded joint is formed point-like or as a corrugation between the ring and the configuration.

6. Electric miniature motor according to claim 1, wherein the welding between the ring and the configuration occurs at several positions.

7. Bearing arrangement for an electric miniature motor, comprising:
a) a metallic configuration for seating a sleeve bearing at an end face of stationary assemblies of the miniature motor;
b) a sleeve bearing of sintered material inserted into a massive ring of weldable material having an outer diameter which is less than the inner diameter of the configuration; and
c) at least one welded joint connecting this ring to the configuration.

8. Method for fabricating an electric miniature motor, comprising:
a) undisplaceably mounting a sleeve bearing of a sintered material which is undisplaceably inserted into a massive ring of a weldable material on the shaft of a rotor assembly of the miniature motor;
b) positioning the ring within a configuration for seating the sleeve bearing at an end face of the stationary assemblies of the miniature motor; and
c) welding the ring to the configuration.

9. Method according to claim 8, wherein the welding of the ring to the configuration occurs through the configuration.

10. Method according to claim 8, wherein the welding of the ring to the configuration occurs at the front side at an end face of the stationary assemblies of the miniature motor at the contact edge of the two components.
